(19) United States
(12) Patent Application Publication
(10) Pub. No.: US 2010/0208997 A1
(43) Pub. Date: Aug. 19, 2010

(54) Image-Based Advertisement Platform

(75) Inventors: Xing Xie, Beijing (CN); Matthew R. Scott, Beijing (CN); Dechao Liu, Beijing (CN); Wei Jiang, Beijing (CN); Jonathan Tien, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/371,640

(22) Filed: Feb. 16, 2009

(51) Int. Cl. G06K 9/46; G06K 9/68

(52) U.S. Cl. 382/195; 382/217; 382/190

(57) ABSTRACT

Described is an image centric advertisement platform and technology in which input images are matched to advertisements based on actual visible content (e.g., corresponding to features) within the image. Advertisers upload and bid on advertiser-provided images that correspond to advertisements. When an input image is received, such as a result of user interaction with web content or transmission of the image by a user, (e.g., via MMS), the image is matched to an advertiser images, such as via feature-based image matching. An index based upon the features may be used for efficiently locating the advertisement or advertisements. Also described is a tool for advertisers to use in creating a new scene based upon an uploaded image, or for adding the uploaded image to an existing scene.

### BACKGROUND

In contemporary online advertisement platforms, whether or not an advertisement is deemed relevant for a user is largely decided by advanced keyword matching. Typically, in a Pay-Per-Click (PPC) model, advertisers specify the words that are to trigger their advertisements and the maximum amount they are willing to pay per click. When a user enters a search query, browses a web page, or in general interacts with some text, the advertisement platform selects and shows relevant advertisements based on the text content in the query or the page.

Although other contextual information such as location, time, and user profile data may be taken into consideration, textual understanding is still the primary technology in advertisement selection. However, other than text, there is no known mechanism for relating image content to advertisements.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology, such as implemented in a platform that returns advertisements to application servers, by which an input image is image matched against advertiser-provided image-related data to locate a relevant advertisement that applies to the input image. For example, a user may identify an image based upon interaction with web content or may transmit an image, and in response receive one or more advertisements. Advertisers may bid on images and scenes of images to match against input images. A region of interest within an image may be bid and/or matched rather than an entire image; when matching images, different image regions may have different weights according to associated interest maps.

In one aspect, advertiser-provided images are processed into features. The features are associated with advertisements, such as by being used to index advertisements. When an input image is received, features are similarly extracted from the input image, and used (e.g., as an index) to locate one or more relevant advertisements.

In one aspect, advertisers may use a tool to create a new scene based upon an uploaded image, or add the uploaded image to an existing scene. An advertiser may also add context to the image/scene, such as commercial information about the scene.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for coupling an image-based advertising platform to user-provided input images.

FIG. 2 is a block diagram representing example components of an advertisement platform server.

FIG. 3 is a flow diagram showing example steps taken to process an advertiser-provided image for inclusion in an advertisement data store for subsequent matching to an input image.

FIG. 4 is a representation of an example image and an associated region of interest map in which shading indicates different weights for different regions of interest.

FIG. 5 is a flow diagram showing example steps taken to process a user-provided input image for locating a relevant advertisement based on features of the input image.

FIG. 6 shows an illustrative example of a computing environment into which various aspects of the present invention may be incorporated.

### DETAILED DESCRIPTION

Various aspects of the technology described herein are generally directed towards an image-based advertisement platform, in which advertisers bid on images (instead of or in addition to keywords). In general, this platform applies to scenarios in which images are the main input or consumed content, for example, in content-based image retrieval or Multimedia Messaging Service (MMS) applications. Users receive advertisements based on the content of images that they recently interacted with, e.g., browsed or used. As described below, one implementation of such a platform is based upon image content understanding, image matching, and user understanding; also included is an advertisement editorial tool.

While an advertisement model is described herein, it should be understood that this is only one practical example, and other (e.g., non-commercial) uses for the image-related technology described herein are feasible. Further, billboard images are used herein as one example type of images. However, it should be understood that advertisers may bid on any images that may be easily recognized. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing, image technology and online advertising in general.

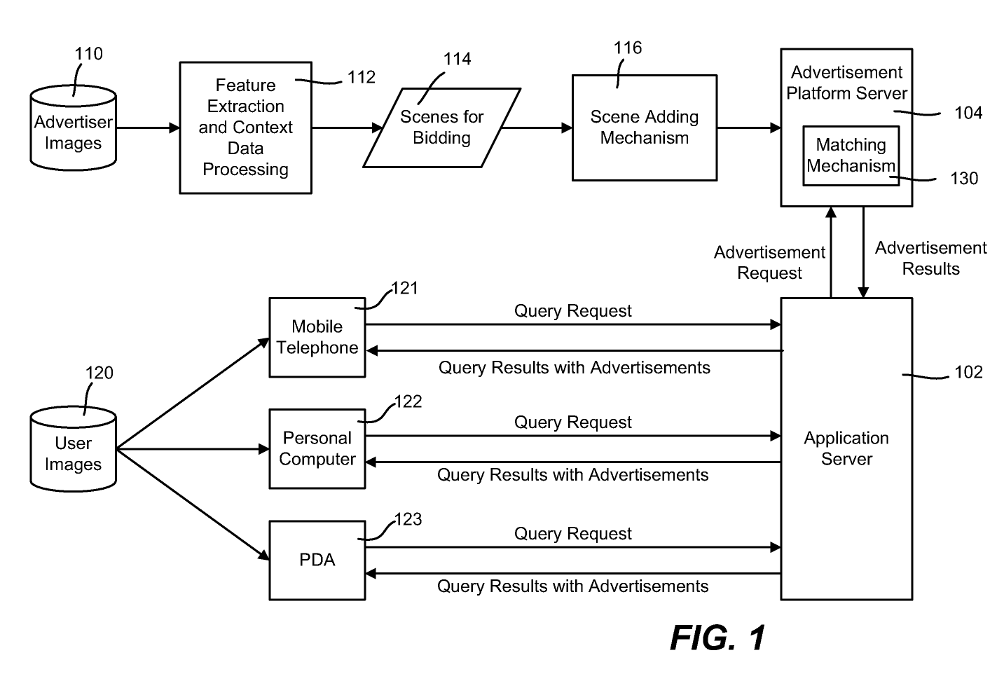

FIG. 1 shows various aspects related to an end-to-end user scenario for an image centric advertisement platform. An application server 102 hosts services in which images comprise part of the input or consumed content. Examples of such services include Multimedia Messaging Service (MMS) and content-based image retrieval.

In general, advertisers may upload and bid on images 110, instead of (or in addition to) text, and this information is maintained on the advertisement platform server 104 as generally described below. These images are associated with bids and matched to an input image for purpose of returning one or more relevant advertisements. For example, a toy seller may bid on the image of a related movie poster, while a restaurant may bid on an image corresponding to a cooking magazine's cover. Note that an image need not be an entire image, but rather some region thereof. For example, an advertiser may be on a logo within images, so that, for example, whenever a user sends an image with such a logo, a match will be detected. As can be readily appreciated, the same image may thus have different bids associated with different regions of that image, with possibly different advertisers.

To maintain information about an image for subsequent matching purposes, a feature extractor mechanism 112 extracts features from the advertiser images 110, and processes the content into various scenes 114. Noted that while extracting features from an image is a well-known technology, there is no requirement as to any particular set of features that needs to be used, and any existing features (e.g., the well-known Scale-Invariant Feature Transform, or SIFT features) may be used, and/or other known features, as well as features not yet in use.

Further, note that a scene is a set of one or more images conceptually related in some way. For example, consider a user that takes a picture of a billboard, and that picture corresponds to an input image that an advertiser bids on for the purpose of returning a related advertisement. Because of image matching limitations, it is more likely that the input image will be matched to an advertiser's image if the advertiser has a similar image captured from the same general angle as the input image, with similar lighting conditions, and so forth. To improve the chances of matching an input image, the advertiser may choose to provide a scene comprising multiple images, such as various images of the same object taken at different angles and lighting conditions. Note however that different advertisers may bid on different images of the same object or the like, e.g., a helicopter tour service may bid on an aerial view of a coastline, while two resorts may bid on different images of the same coastline each taken from their resort's perspective.

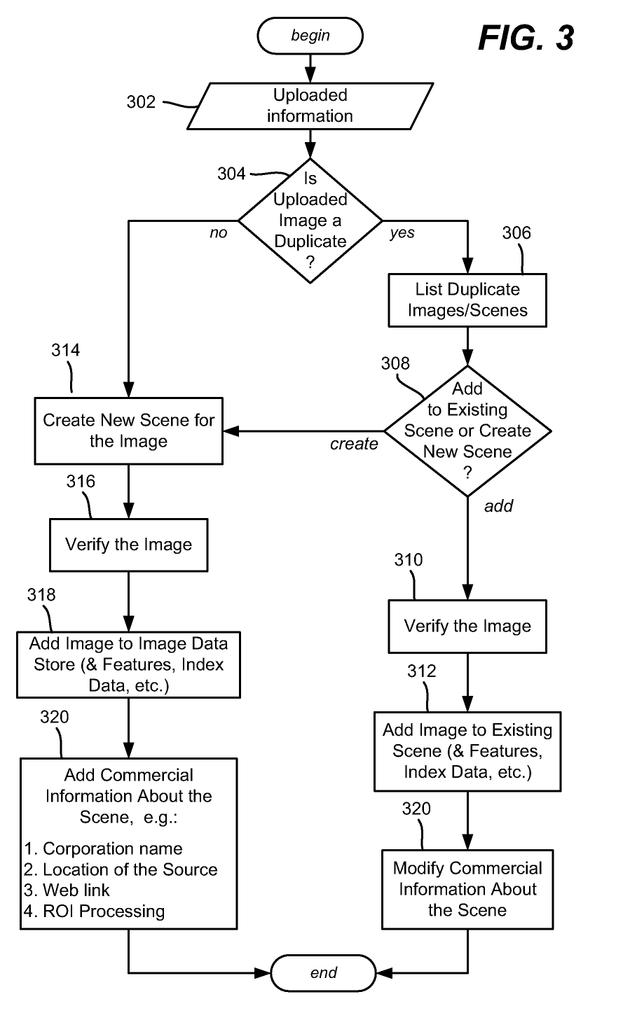

A mechanism 116 adds such advertiser-bid scenes to the advertisement platform server 104. One such mechanism includes a tool that advertisers may use, as generally described below with reference to FIG. 3.

With respect to online processing user queries or other communications, the application server 102 communicates with the advertisement platform server 104 to obtain relevant advertisements according to user images 120. As represented in FIG. 1, such user images 120 may be provided (and possibly captured) via a mobile telephone device 121, a personal computer 122, and/or a personal digital assistant 123, however as can be readily appreciated, other such communication devices that can receive and/or transmit image data may be used.

In general, a matching mechanism 130 of the advertisement platform server 104 returns one or more advertisements based upon a query input image (or part of that image, referred to as a scene). An image may be obtained as a query whenever a user interacts with (e.g., clicks on or hovers over) an image on a web page. In addition to queries that correspond to images related to web-page browsing and the like, a query may be based upon an image that is communicated in some other way. For example, a user may send an image via MMS to another user, and either or both users may receive an advertisement matched to that image by treating that image as a query (when received by the MMS service). A user may also take a picture of something and request related advertising; for example, a user may take a picture of a commercial product, send in the picture, and receive a discount coupon as a returned advertisement, (or information as to how to get such a coupon).

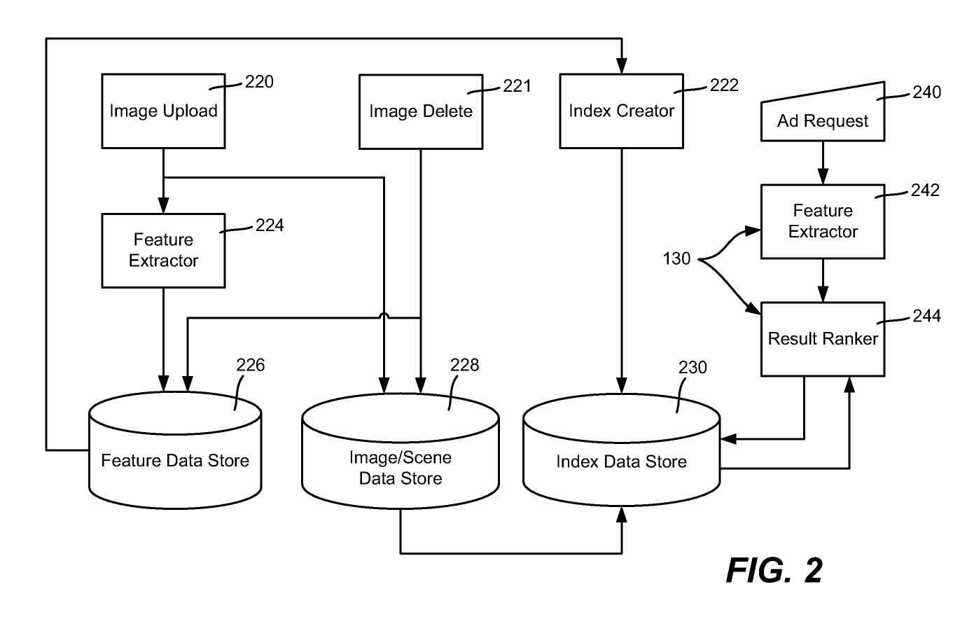

FIG. 2 represents one suitable framework of an advertisement platform server 104. In general, the image upload, image delete, and index creator modules 220-222 are used by advertisers and advertisement platform owners to maintain one or more data stores associated with the advertisement platform server 104.

More particularly, as described above, uploaded advertisement images (module 220) are processed into features (block 224) that are maintained in a feature data store 226. Each image or scene within an image is maintained in an image/scene data store 228; note that both data stores may be accessed by the image delete module 221, such as to delete old images. For efficiency, via the index creator module 222, the features may be used as an index to efficiently locate a scene/associated advertisement as referenced in an index data store 230, e.g., the features may correspond to one or more keys.

To online match an image to an advertisement, the framework accepts an input query as an advertisement request 240, which includes the input image and any related context information (described below). The image part of the request 240 similarly has its features extracted (block 242) for matching with the features of the advertisement images. For example, if the features are used as keys to the index data store 230, relevant advertisements may be looked up and ranked based on similarity to the features of the advertisers' images/scenes. To this end, a result ranker 244 selects the closest matching advertisement (or ranked set of advertisements) based on the entries in the index data store 230; note that blocks 242 and 244 of FIG. 2 generally correspond to the matching mechanism 130 of FIG. 1. While any suitable image matching technology may be used, one implementation is based on technology described in copending U.S. patent application Ser. No. 12/245,710 entitled “Incremental Feature Indexing for Scalable Location Recognition”), and U.S. published patent applications nos. 20080205770, (“Generating a Multi-Use Vocabulary based on Image Data”), 20070237426 (“Generating Search Results based on Duplicate Image Detection”) and 20070067345 (“Generating Search Requests from Multimodal Queries”), herein incorporated by reference.

FIG. 3 is a flow diagram representing example steps of an advertisement editorial tool, such as corresponding to the mechanism 116 of FIG. 1. This tool is used by advertisers to interact with the advertisement platform server 104, and helps advertisers upload and bid on images (step 302).

In general, images are organized into scenes which represent a particular visual object that can be bid by advertisers. As generally represented at step 304, the tool checks whether an uploaded images is a duplicate (that is, a close copy) of an existing scene already in the advertisement platform server. If so, step 306 identifies the duplicate images or scenes to the advertiser, to give the advertiser the opportunity to evaluate the images. For example, this addition may be an error, and although not explicitly shown in FIG. 3, the advertiser may cancel out of the process at any time. However, an advertiser may specifically want an image that is a near duplicate (e.g., taken with slightly different lighting) to be included in an existing scene, and the advertiser can do so even though the process flagged the scene as a duplicate. Further, the advertiser may want to use an exact or very similar image to create a new scene.

If the advertiser elects to continue, step 308 asks the advertiser whether the image is to be added to an existing scene, or to be used in creating a new scene. If added, step 308 branches to step 310 which represents some manual and/or automated process verifying the image. This ensures that an advertiser does not include an image that may compromise the system in some way. Step 312 then adds the image (assuming verified as acceptable), as well as adding features and indexing data to the appropriate data stores. Step 314 modifies any commercial information associated with the image and/or scene, as described below.

If not a duplicate image at step 302 or if the advertiser has elected to create a new scene at step 308, step 314 is executed to create a new scene for the image. Step 316 verifies the image, which if verified as acceptable, is added to the image data store at step 318. Step 318 also represents as adding the features and indexing data to the appropriate data stores.

Step 320 represents associating commercial information with the scene. This provides context which may help in image matching/advertisement retrieval performance, as well as for other purposes. For example, the corporation name, geographical location of the source of the image (e.g., where the billboard is located), a web URL and interest map data (corresponding to what location within each image is of what interest) may be added.

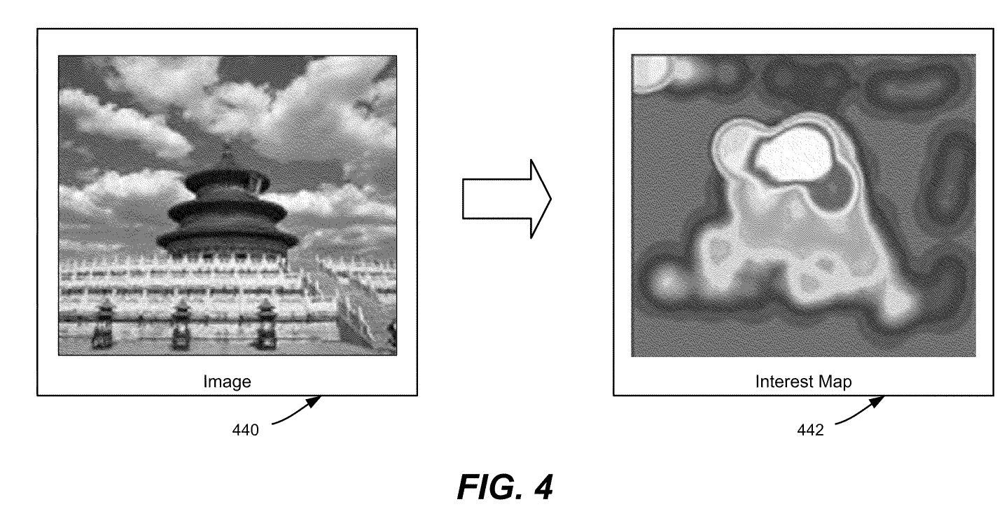

FIG. 4 shows the concept of a region of interest for an example image 440. The image 442 is an interest map for the source image 440, with different shades indicating different weights (note that in one actual implementation, colors are used instead of shading). When matching two images, the interest map may be used to give greater importance to those matches that appear in higher weighted regions.

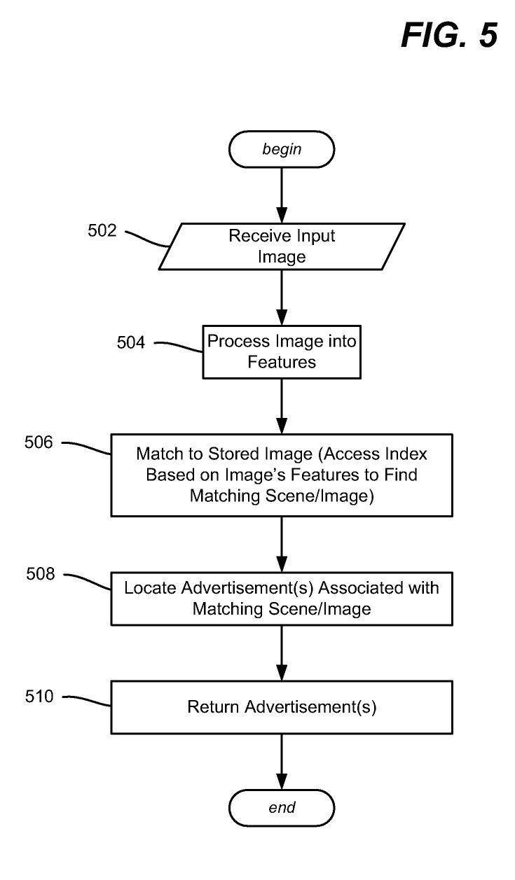

FIG. 5 is a flow diagram representing processing of an input image to locate a relevant set of one or more advertisements, beginning at step 502 where the image is received. Step 504 processes the images into features, and step 506 uses the features to find a matching scene/image within a scene, e.g., by accessing the index. Note that region of interest weighting may be used, as generally described above.

Step 508 represents locating the advertisement content based upon the match with the input image's features. Step 510 returns the advertisement set.

### Exemplary Operating Environment

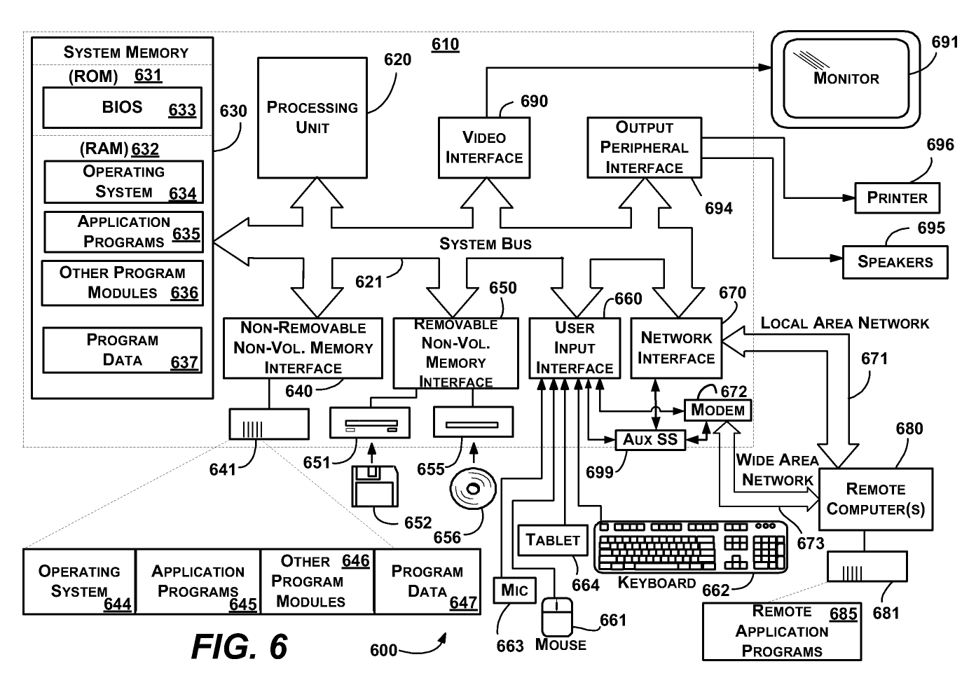

FIG. 6 illustrates an example of a suitable computing and networking environment 600 on which the examples of FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, receiving an input image, matching at least part of the input image against maintained image-related data to locate a relevant advertisement that applies to the input image, and outputting the relevant advertisement.

2. The method of claim 1 wherein receiving the input image comprises receiving data indicative of user interaction with web content.

3. The method of claim 1 wherein receiving the input image comprises receiving the image as part of a communication from a user.

4. The method of claim 1 wherein matching at least part of the input image comprises processing the image into features.

5. The method of claim 1 wherein matching at least part of the input image comprises processing the image into features, and using the features to access an index by which the advertisements are located.

6. The method of claim 1 wherein matching at least part of the input image comprises matching a region of interest within the image to the image-related data.

7. The method of claim 6 wherein matching the region of interest comprises obtaining region-based weight information that associates different weighting information with different regions.

8. In a computing environment, a system comprising, an advertisement platform service that obtains an input image, the advertisement platform service configured with a matching mechanism that locates an advertisement that matches the input image, and the advertisement platform returning the advertisement.

9. The system of claim 8 wherein the advertisement platform service includes a feature extractor that extracts features from the input image, and a mechanism that locates the advertisement based upon the features.

10. The system of claim 8 further comprising an application server coupled for communication with the advertisement platform service, the advertisement platform service obtaining the input image from the application server and returning the advertisement to the application server.

11. The system of claim 8 wherein the advertisement platform service includes an advertiser image upload component coupled to a feature extractor component that extracts features from the advertiser image for use in matching with features of input images.

12. The system of claim 11 wherein the advertisement platform service includes a feature extractor that extracts features from the input image and a feature extractor component that extracts features from advertiser images, the features of the input image used to access an index that is based upon the features of the advertiser images to locate the advertisement that matches the input image.

13. The system of claim 11 wherein the advertisement platform service includes a feature data store that contains features extracted from advertiser images, an image/scene data store that contains images and scenes provided by advertisers, and means for adding to and deleting features from the feature data store and images and scenes from the image/scene data store.

14. The system of claim 11 further comprising a scene adding mechanism coupled to the advertisement platform server, the scene adding tool including means for adding an advertiser image to an existing scene, or using an advertiser image to create a new scene.

15. The system of claim 14 wherein the scene adding mechanism includes means for associating related information with the new scene, or modifying related information associated with an existing scene, the related information including a name, a location, a link, or data related to a region of interest, or any combination of a name, a location, a link, or data related to a region of interest.

16. One or more computer-readable media having computer-executable instructions, which when executed perform steps, comprising:
maintaining data corresponding to advertiser images;
obtaining an input image;
extracting features of the input image; and
using the features of the input image to locate an advertisement based upon the maintained data that corresponds to the advertiser images.

17. The one or more computer-readable media of claim 16 wherein using the features of the input image to locate the advertisement comprises accessing an index that relates features to advertisements.

18. The one or more computer-readable media of claim 17 having further computer-executable instructions comprising creating the index based upon features extracted from the advertiser images.

19. The one or more computer-readable media of claim 17 having further computer-executable instructions comprising processing an uploaded advertiser image for inclusion in the maintained data, including data corresponding to the uploaded advertiser image in an existing scene, or creating a new scene based upon the uploaded advertiser image.

20. The one or more computer-readable media of claim 17 having further computer-executable instructions comprising processing an uploaded advertiser image for inclusion in the maintained data, including extracting features of the uploaded image.
